(19) United States
(12) Patent Application Publication
(10) Pub. No.: US 2026/0074736 A1
(43) Pub. Date: Mar. 12, 2026

(54) TRANSMIT-RECEIVE (TR) SWITCH ARCHITECTURE FOR ELECTROSTATIC DISCHARGE (ESD) PROTECTION

(71) Applicant: QUALCOMM Incorporated, San Diego, CA (US)

(72) Inventors: Zaid ABOUSH, Chandler, AZ (US); Dayasagar GAADE, Irvine, CA (US)

(21) Appl. No.: 19/226,614

(22) Filed: Jun. 3, 2025

Related U.S. Application Data
(60) Provisional application No. 63/693,142, filed on Sep. 10, 2024.

(51) Int. Cl. H04B 1/44; H04B 1/405

(52) U.S. Cl. CPC H04B 1/44; H04B 1/405

(57) ABSTRACT

Certain aspects of the present disclosure are directed towards a transceiver. An example transceiver generally includes: a transmit amplifier with an output coupled to a node of the transceiver; a receive amplifier with an input coupled to the node of the transceiver; a transmit-receive switch (TRSW) transistor coupled between the node and a reference potential node; and one or more diodes coupled between the node and a gate of the TRSW transistor.

### CROSS-REFERENCE TO RELATED APPLICATION

This application claims benefit of and priority to U.S. Provisional Application No. 63/693,142 filed September 10, 2024, which is hereby expressly incorporated by reference herein in its entirety as if fully set forth below and for all applicable purposes.

### TECHNICAL FIELD

Certain aspects of the present disclosure generally relate to electronic circuits and, more particularly, to techniques and apparatus for electrostatic discharge protection.

### BACKGROUND

Wireless communication devices are widely deployed to provide various communication services such as telephony, video, data, messaging, broadcasts, and so on. Such wireless communication devices may transmit and/or receive radio frequency (RF) signals via any of various suitable radio access technologies (RATs) including, but not limited to, Fifth Generation (5G) New Radio (NR), Long Term Evolution (LTE), Code Division Multiple Access (CDMA), Time Division Multiple Access (TDMA), Wideband CDMA (WCDMA), Global System for Mobility (GSM), Bluetooth, Bluetooth Low Energy (BLE), Zigbee, wireless local area network (WLAN) RATs (e.g., WiFi), and the like.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station. The base station and/or mobile station may include one or more transmitters and receivers.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide advantages described herein.

Certain aspects of the present disclosure are directed towards a transceiver. The transceiver generally includes: a first amplifier coupled to an input-output (IO) node; a second amplifier coupled to the IO node; a transmit-receive (TR) switch coupled between the IO node and a reference potential node; and one or more diodes coupled between the IO node and a gate of a first transistor used to implement the TR switch.

Certain aspects of the present disclosure are directed towards a transceiver. The transceiver generally includes: a transmit amplifier with an output coupled to a node of the transceiver; a receive amplifier with an input coupled to the node of the transceiver; a transmit-receive switch (TRSW) transistor coupled between the node and a reference potential node; and one or more diodes coupled between the antenna node and a gate of the TRSW transistor.

Certain aspects of the present disclosure are directed towards a method for electrostatic discharge (ESD) protection. The method generally includes: receiving a first signal at a node of a transceiver, wherein the transceiver includes a transmit amplifier with an output coupled to the node, a receive amplifier with an input coupled to the node, and a TRSW transistor coupled between the node and a reference potential node; and generating, via one or more diodes coupled to the node, a first voltage at a gate of the TRSW transistor based on the first signal.

Certain aspects of the present disclosure are directed towards a transceiver. The transceiver generally includes: a transmit amplifier with an output coupled to a node of the transceiver; a receive amplifier with an input coupled to the node of the transceiver; a capacitive element coupled between a voltage rail and a reference potential node; a transistor coupled between the capacitive element and the node; and one or more diodes coupled between the voltage rail and a gate of the transistor.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in which aspects of the present disclosure may be practiced.

FIG. 2 is a block diagram conceptually illustrating a design of an example base station (BS) and user equipment (UE), in which aspects of the present disclosure may be practiced.

FIG. 3 is a block diagram of an example radio frequency (RF) transceiver, in which aspects of the present disclosure may be practiced.

FIGS. 4A and 4B illustrate an example transceiver implemented with electrostatic discharge (ESD) protection, in accordance with certain aspects of the present disclosure.

FIG. 5 is a flow diagram illustrating example operations for ESD protection, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed toward techniques and apparatus for providing electrostatic discharge (ESD) protection for a transceiver. The ESD protection may be provided by turning on a transmit-receive switch (TRSW) transistor in the presence of a positive voltage (or turning on a p-type metal-oxide-semiconductor (PMOS) transistor in the presence of a negative voltage) at a node of the transceiver due to ESD. For example, one or more diodes may be implemented between the node of the transceiver and a gate of the TRSW transistor. The one or more diodes may begin to conduct current from the node to the gate of the TRSW transistor to generate a voltage at a gate of the TRSW transistor such that the TRSW transistor sinks a current (e.g., ESD current) from the node to a reference potential node (e.g., electric ground) for ESD protection.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Wireless System

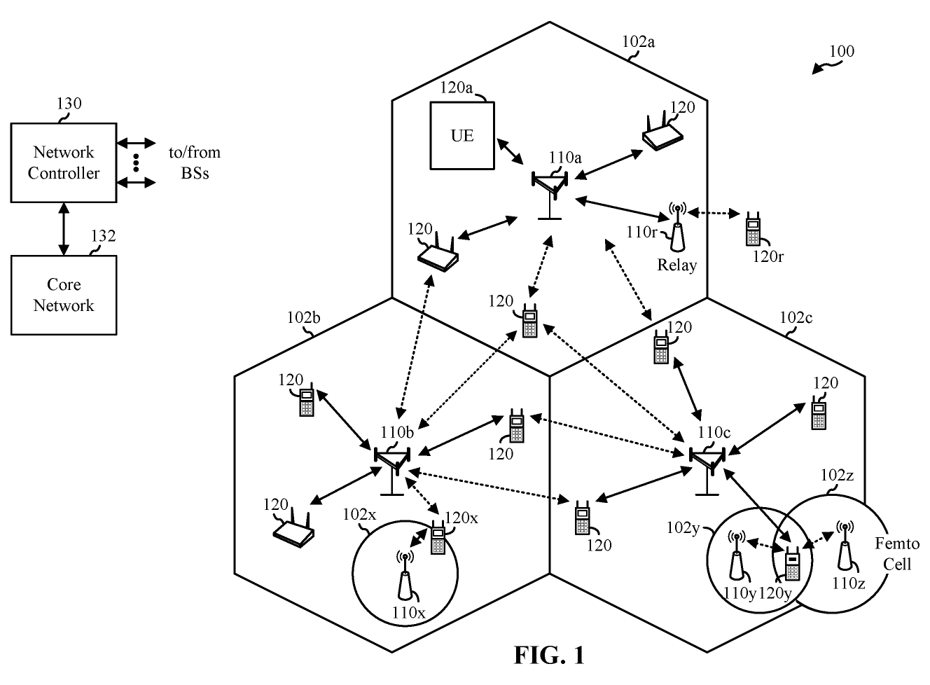

FIG. 1 illustrates an example wireless communications network 100, in which aspects of the present disclosure may be practiced. For example, the wireless communications network 100 may be a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation/Third Generation (2G/3G) network), or a code division multiple access (CDMA) system (e.g., a 2G/3G network), or may be configured for communications according to an IEEE standard such as one or more of the 802.11 standards, or Bluetooth (BT).

As illustrated in FIG. 1, the wireless communications network 100 may include a number of base stations (BSs) 110a-z (each also individually referred to herein as “BS 110” or collectively as “BSs 110”) and other network entities. A BS may also be referred to as an access point (AP), an evolved Node B (eNodeB or eNB), a next generation Node B (gNodeB or gNB), or some other terminology.

A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communications network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with one or more user equipments (UEs) 120a-y (each also individually referred to herein as “UE 120” or collectively as “UEs 120”) in the wireless communications network 100. A UE may be fixed or mobile and may also be referred to as a user terminal (UT), a mobile station (MS), an access terminal, a station (STA), a client, a wireless device, a mobile device, or some other terminology. A user terminal may be a wireless device, such as a cellular phone, a smartphone, a personal digital assistant (PDA), a handheld device, a wearable device, a wireless modem, a laptop computer, a tablet, a personal computer, etc.

The BSs 110 are considered transmitting entities for the downlink and receiving entities for the uplink. The UEs 120 are considered transmitting entities for the uplink and receiving entities for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink. N up UEs may be selected for simultaneous transmission on the uplink, N dn UEs may be selected for simultaneous transmission on the downlink. N up may or may not be equal to N dn, and N up and N dn may be static values or can change for each scheduling interval. Beam-steering or some other spatial processing technique may be used at the BSs 110 and/or UEs 120.

The UEs 120 (e.g., 120x, 120y, etc.) may be dispersed throughout the wireless communications network 100, and each UE 120 may be stationary or mobile. The wireless communications network 100 may also include relay stations (e.g., relay station 110r), also referred to as relays or the like, that receive a transmission of data and/or other information from an upstream station (e.g., a BS 110a or a UE 120r) and send a transmission of the data and/or other information to a downstream station (e.g., a UE 120 or a BS 110), or that relays transmissions between UEs 120, to facilitate communication between devices.

The BSs 110 may communicate with one or more UEs 120 at any given moment on the downlink and uplink. The downlink (i.e., forward link) is the communication link from the BSs 110 to the UEs 120, and the uplink (i.e., reverse link) is the communication link from the UEs 120 to the BSs 110. A UE 120 may also communicate peer-to-peer with another UE 120.

The wireless communications network 100 may use multiple transmit and multiple receive antennas for data transmission on the downlink and uplink. BSs 110 may be equipped with a number N ap of antennas to achieve transmit diversity for downlink transmissions and/or receive diversity for uplink transmissions. A set N u of UEs 120 may receive downlink transmissions and transmit uplink transmissions. Each UE 120 may transmit user-specific data to and/or receive user-specific data from the BSs 110. In general, each UE 120 may be equipped with one or multiple antennas. The N u UEs 120 can have the same or different numbers of antennas.

The wireless communications network 100 may be a time division duplex (TDD) system or a frequency division duplex (FDD) system. For a TDD system, the downlink and uplink share the same frequency band. For an FDD system, the downlink and uplink use different frequency bands. The wireless communications network 100 may also utilize a single carrier or multiple carriers for transmission. Each UE 120 may be equipped with a single antenna (e.g., to keep costs down) or multiple antennas (e.g., where the additional cost can be supported).

A network controller 130 (also sometimes referred to as a “system controller”) may be in communication with a set of BSs 110 and provide coordination and control for these BSs 110 (e.g., via a backhaul). In certain cases (e.g., in a 5G NR system), the network controller 130 may include a centralized unit (CU) and/or a distributed unit (DU). In certain aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

In some aspects, the BS 110 and/or UE 120 may include a time division duplexing (TDD) transceiver with a transmit-receive switch (TRSW) that may be used for electrostatic discharge (ESD) protection.

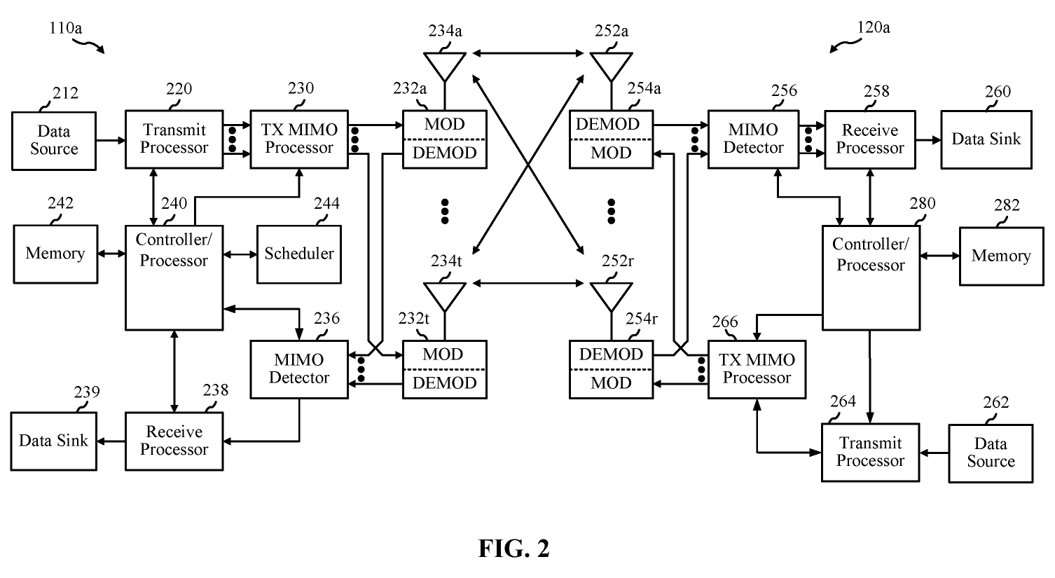

FIG. 2 illustrates example components of BS 110a and UE 120a (e.g., from the wireless communications network 100 of FIG. 1), in which aspects of the present disclosure may be implemented.

On the downlink, at the BS 110a, a transmit processor 220 may receive data from a data source 212, control information from a controller/processor 240, and/or possibly other data (e.g., from a scheduler 244). The various types of data may be sent on different transport channels. For example, the control information may be designated for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be designated for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS).

A transmit (TX) multiple-input, multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 232a-232t may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. The memories 242 and 282 may also interface with the controllers/processors 240 and 280, respectively. A scheduler 244 may schedule UEs for data transmission on the downlink and/or uplink.

In some aspects, one or more of the transceivers 232a-232t and transceivers 254a-254r may include a TDD transceiver with a TRSW that may be used for ESD protection.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The system bandwidth may also be partitioned into subbands. For example, a subband may cover multiple resource blocks (RBs).

### Example RF Transceiver

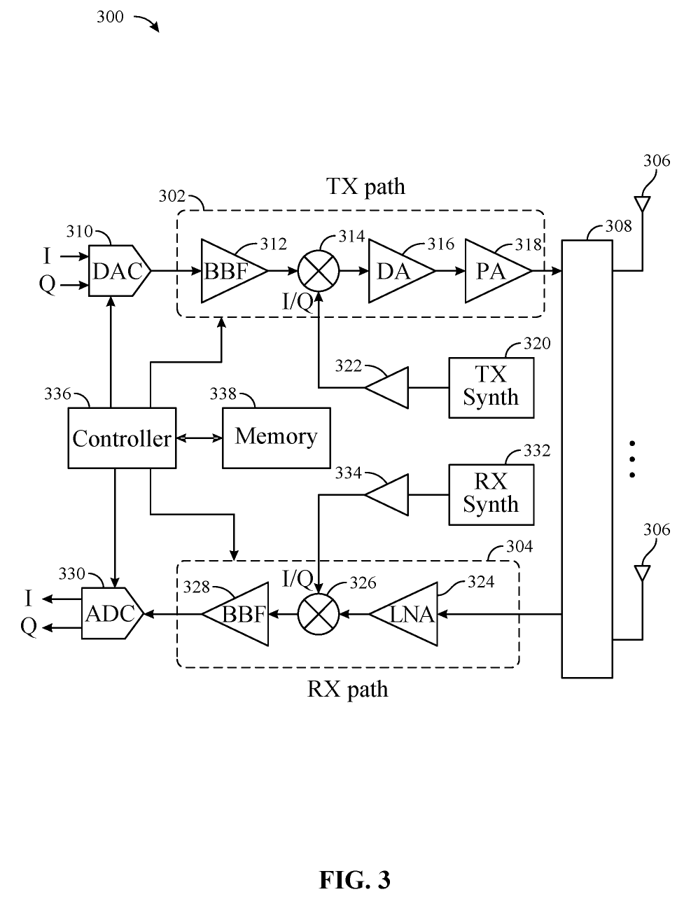

FIG. 3 is a block diagram of an example radio frequency (RF) transceiver circuit 300, in accordance with certain aspects of the present disclosure. The RF transceiver circuit 300 includes at least one transmit (TX) path 302 (also known as a “transmit chain”) for transmitting signals via one or more antennas 306 and at least one receive (RX) path 304 (also known as a “receive chain”) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) and/or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, the DA 316, and the PA 318 may be included in a radio frequency integrated circuit (RFIC). For certain aspects, the PA 318 may be external to the RFIC. While a Cartesian transceiver is described herein to facilitate understanding, some aspects of the present disclosure may be applied to any suitable transmitter configuration such as a polar transmitter.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency-conversion process produces the sum and difference frequencies between the LO frequency and the frequencies of the baseband signal of interest. The sum and difference frequencies are referred to as the “beat frequencies.” The beat frequencies are typically in the RF range, such that the signals output by the mixer 314 are typically RF signals, which may be amplified by the DA 316 and/or by the PA 318 before transmission by the antenna(s) 306. While one mixer 314 is illustrated, several mixers may be used to upconvert the filtered baseband signals to one or more intermediate frequencies and to thereafter upconvert the intermediate frequency (IF) signals to a frequency for transmission.

The RX path 304 may include a low noise amplifier (LNA) 324, a mixer 326, and a baseband filter (BBF) 328. The LNA 324, the mixer 326, and the BBF 328 may be included in one or more RFICs, which may or may not be the same RFIC that includes the TX path components. RF signals received via the antenna(s) 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328 before being converted by an analog-to-digital converter (ADC) 330 to digital I and/or Q signals for digital signal processing.

In some aspects, the PA and the LNA may be a part of a time division duplexing (TDD) transceiver with a transmit-receive switch (TRSW) that may be used for electrostatic discharge (ESD) protection.

Certain transceivers may employ frequency synthesizers with a variable-frequency oscillator (e.g., a voltage-controlled oscillator (VCO) or a digitally controlled oscillator (DCO)) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326. For certain aspects, a single frequency synthesizer may be used for both the TX path 302 and the RX path 304. In certain aspects, the TX frequency synthesizer 320 and/or RX frequency synthesizer 332 may include a frequency multiplier, such as a frequency doubler, that is driven by an oscillator (e.g., a VCO) in the frequency synthesizer.

A controller 336 (e.g., controller/processor 280 in FIG. 2) may direct the operation of the RF transceiver circuit 300, such as transmitting signals via the TX path 302 and/or receiving signals via the RX path 304. The controller 336 may be a processor, a digital signal processor (DSP), an application-specific integrated circuit (ASIC), a field-programmable gate array (FPGA) or other programmable logic device (PLD), discrete gate or transistor logic, discrete hardware components, or any combination thereof. A memory 338 (e.g., memory 282 in FIG. 2) may store data and/or program codes for operating the RF transceiver circuit 300. The controller 336 and/or the memory 338 may include control logic (e.g., complementary metal-oxide-semiconductor (CMOS) logic).

While FIGS. 1-3 provide wireless communications as an example application in which certain aspects of the present disclosure may be implemented to facilitate understanding, certain aspects described herein may be used for any of various other suitable systems.

### Example Techniques and Circuitry for ESD Protection

Modern time division duplexing (TDD) transceivers use a shared radio frequency input-output (RFIO) pin for both transmit and receive (TR) to reduce the footprint and cost of the radio frequency (RF) circuitry (e.g., RF integrated circuit (RFIC)). On-chip TR switch(es) (e.g., TR switch integrated into the RFIC) may be used to maintain proper impedance matching during transmission (TX) and/or reception (RX) as well as to protect a receiver from an excessive TX voltage swing during transmission that may otherwise damage the transceiver’s input devices such as low-noise amplifier (LNA) input devices.

The electrostatic discharge (ESD) protection for the RFIO pin may prove challenging as some ESD protection mechanisms may result in parasitic capacitive loading at the RFIO pin, impacting the RX noise FIGURE(NF), maximum TX output swing, and TX/RX linearity. An on-chip TR switch (TRSW) may be direct current (DC) coupled to the RFIO pin, which may provide ESD protection. In some cases, the size of the TR switch may be set to decrease RX and TX error vector magnitude (EVM) performance. ESD diodes may also be added to provide ESD protection but may still be insufficient to meet ESD specifications. Certain aspects of the present disclosure are directed toward apparatus and techniques for using the TRSW to increase ESD protection.

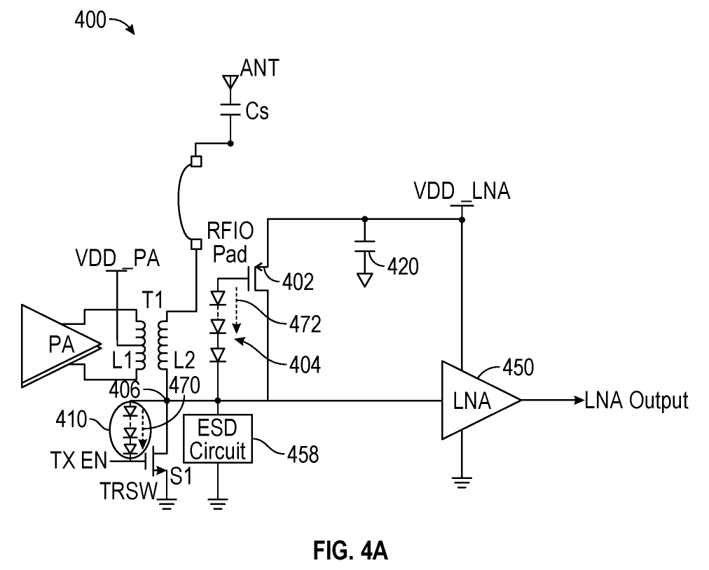

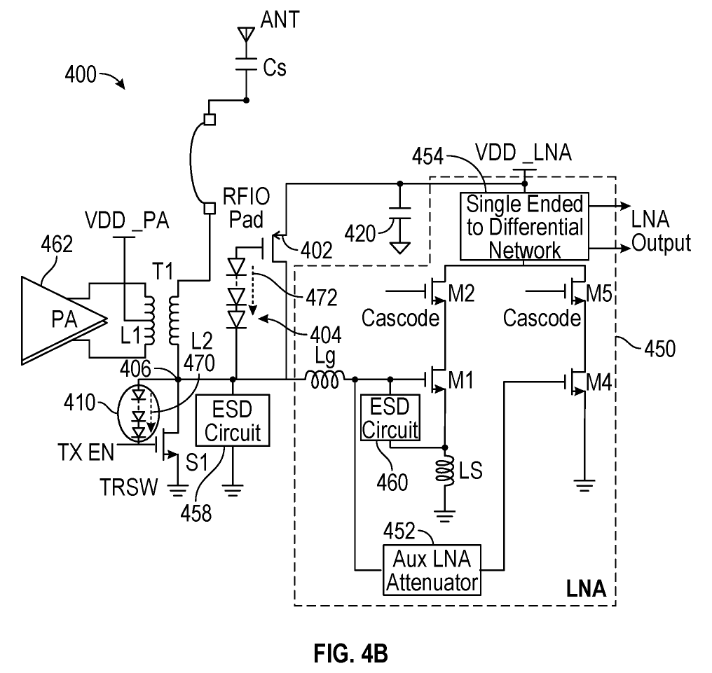

FIG. 4A illustrates an example transceiver 400 implemented with ESD protection using a TRSW, in accordance with certain aspects of the present disclosure. FIG. 4B illustrates the example transceiver 400 showing implementation details of an example LNA 450 of the transceiver 400, in accordance with certain aspects of the present disclosure. While an example circuit topology for the LNA 450 is shown in FIG. 4B to facilitate understanding, any suitable LNA topology may be used.

As shown in FIG. 4B, the transceiver 400 may include an LNA 450 (e.g., corresponding to LNA 324 of FIG. 3) including input transistors M1 and M4, coupled in cascode with respective cascode transistors M2, M5. A source inductive element Ls may be coupled between the source of transistor M1 and the reference potential node (e.g., electric ground). A gate inductive element Lg may be coupled between node 406 and the gate of transistor M1. An attenuator 452 (e.g., auxiliary LNA attenuator) may be coupled between the inductive element Lg and the gate of input transistor M4, as shown. A single-ended to differential network 454 may receive a supply voltage (VDD_LNA) and may be coupled between the drains of transistors M2, M5 and the differential output of the LNA 450.

Stacked ESD diodes may be used to protect sensitive circuits such as LNA input devices (e.g., transistor M1 of the LNA) against ESD signals associated with a human body model (HBM) and/or a charged device model (CDM). For example, the ESD circuit 458 may include diodes for ESD protection close to the RFIO pad to protect against HBM ESD signals (e.g., an ESD signal that a human body may cause). The ESD circuit 460 may include another set of diodes close to the LNA input device (e.g., between the gate and the source of transistor M1) to protect against CDM ESD signals (e.g., signals caused by an electrostatically charged device). Each ESD structure (e.g., each of ESD circuits 458, 460) may include one or more stacked reverse-biased ESD diodes to protect during a negative zap event (e.g., when the voltage at node 406 goes negative with respect to ground due to ESD), and one or more stacked forward-biased ESD diodes to protect during a positive zap event (e.g., when the voltage at node 406 goes positive with respect to ground due to ESD).

However, the diodes of the ESD circuits 458, 460 may be small in order to avoid the diodes adversely impacting RF performance. Due to the small size of the diodes, the diodes may not be able to pass a sufficient amount of ESD current to ground protect the transceiver. That is, the voltage across the diodes may be bounded by the diodes’ physical size and routing parasitics, mainly resistance.

Certain aspects of the present disclosure are directed toward improving the ESD performance without increasing the size of the TRSW or ESD diodes. The ESD protection techniques described herein may be tuned to increase TX and RX performance. For example, certain aspects may provide a circuit topology that allows the usage of a TRSW (e.g., having a low impedance due to the large size of the TRSW) to operate as part of the ESD protection circuit and, hence, pass the majority of the ESD current. The TRSW may be a large switch providing low impedance and, thus, may be capable of passing a large amount of ESD current to the reference potential node (e.g., electric ground) for ESD protection.

As shown, the transceiver 400 may include a TRSW (labeled “S1”). The TRSW may be closed during transmission using a transmission enable (TX EN) signal to couple node 406 to the reference potential node (e.g., electric ground). During transmission, the power amplifier (PA) 462 (e.g., corresponding to PA 318 of FIG. 3) drives a primary winding L1 of a transformer T1, where the primary winding is magnetically coupled to a secondary winding L2 coupled between the RFIO pad and the node 406. As shown, a tap of the primary winding L1 may be coupled to a supply voltage rail (VDD_PA).

The TRSW may be opened during reception so that a signal from an antenna (e.g., labeled “ANT,” corresponding to antenna 306 of FIG. 3) can be passed to the LNA 450 (e.g., to the gate of transistor M1). In other words, a received signal from the antenna may be provided to node 406 through a capacitive element Cs and the secondary winding L2.

During transmission, the TRSW may be closed via the TX EN signal, coupling the node 406 to the reference potential node (e.g., electric ground). In some aspects, one or more forward-biased feedback diodes 410 may be coupled between the drain and the gate of the transistor (e.g., n-type metal-oxide-semiconductor (NMOS) transistor) implementing the TRSW (e.g., referred to herein as a “TRSW transistor”), increasing how fast the TRSW turns on in response to an ESD signal at node 406. As shown, the diodes 410 are coupled in series with anodes being coupled towards node 406 and cathodes being coupled towards the gate of the TRSW transistor.

Since the TRSW is large, when the TRSW turns on, the TRSW presents a low impedance path between node 406 (e.g., and the RFIO pin) and the reference potential node. Due to the low TRSW on-impedance, most of the ESD current may flow in the TRSW, developing a low current-resistance (IR) or voltage drop across the drain and source terminals of the transistor implementing the TRSW (referred to herein as the “TRSW transistor”). When the voltage difference across the diodes 410 is greater than the combined threshold voltage of the diodes 410 (e.g., due to a negative or positive zap event), the diodes 410 begin to conduct current 470 and drive the gate of (e.g., generate a gate voltage for) the TRSW transistor, turning on the TRSW transistor to sink current (e.g., ESD current) from the node 406 for ESD protection. In some cases, the diodes 410 may be implemented as small diodes providing only a sufficient amount of current to the gate of the TRSW transistor that biases the TRSW transistor to sink current from the node 406.

While three diodes 410 are shown to facilitate understanding, any suitable number of diodes 410 may be used. Using fewer diodes lowers the total threshold voltage of the diodes, reducing the voltage from ESD that may be applied to the RFIO pin to meet ESD specifications.

A similar approach may be used to protect against a negative zap event using a p-type metal-oxide-semiconductor (PMOS) transistor 402 coupled between the RFIO pin and the supply voltage rail (VDD_LNA) with one or more reverse-biased feedback diodes 404, as shown. For example, the source of transistor 402 may be coupled to VDD_LNA, and the drain of transistor 402 may be coupled to node 406. The diodes 404 may be coupled between the gate of transistor 402 and node 406, as shown. The diodes 404 may include a series of diodes with anodes coupled towards the gate of transistor 402 and cathodes coupled towards node 406. A capacitive element 420 may be coupled between the voltage rail VDD_LNA and the reference potential node (e.g., electric ground). When the voltage at node 406 drops to a negative voltage (e.g., the voltage at node 406 goes negative with respect to ground due to a negative zap event), the diodes 404 begin to conduct, sinking a current 472 (e.g., a transient current) from the gate of the transistor 402 to generate a gate voltage for transistor 402 and turning on the transistor 402. By turning on transistor 402, current (e.g., ESD current) may be sunk from the capacitive element 420 to the node 406 to protect against (e.g., counter the effect of) the negative zap event.

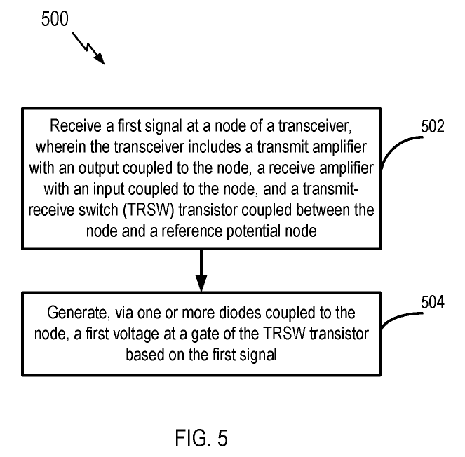

FIG. 5 is a flow diagram illustrating example operations 500 for electrostatic discharge (ESD) protection, in accordance with certain aspects of the present disclosure. The operations 500 may be performed, for example, by a transceiver such as the transceiver 400 of FIG. 4A or FIG. 4B.

At block 502, the transceiver may receive a first signal at a node of a transceiver. The first signal may be an ESD signal. The transceiver includes a transmit amplifier (e.g., PA 462) with an output coupled to the node, a receive amplifier (e.g., LNA 450) with an input coupled to the node, and a transmit-receive switch (TRSW) transistor (e.g., TRSW S1) coupled between the node and a reference potential node. In some aspects, the node may be coupled to an input-output (IO) node (e.g., RFIO pad of FIG. 4A or FIG. 4B) of an integrated circuit including at least a portion of the transceiver.

At block 504, the transceiver may generate, via one or more diodes (e.g., diodes 410) coupled to the node, a first voltage (e.g., by conducting transient current 470 between a reference potential node and the node) at a gate of the TRSW transistor based on the first signal. The one or more diodes may include two or more diodes, in some aspects. In some aspects, the first signal is an ESD signal. The transceiver may conduct ESD current between the node and the reference potential via the TRSW transistor based on the ESD signal.

In some aspects, the transceiver further comprises a transistor (e.g., transistor 402) coupled between a voltage rail and the node, and a capacitive element (e.g., capacitive element 420) coupled between the voltage rail and the reference potential node. The transceiver may receive a second signal (e.g., an ESD signal) at the node of the transceiver. The transceiver may generate, via one or more other diodes (e.g., diodes 404) coupled to the node, a second voltage (e.g., e.g., by conducting transient current 472) at a gate of the transistor based on the second signal. In some aspects, the first voltage is generated via the one or more diodes based on the first signal including a positive voltage with respect to a reference potential at the reference potential node. The second voltage may be conducted via the one or more other diodes based on the second signal including a negative voltage with respect to the reference potential.

In some aspects, the transceiver may turn on the TRSW transistor during transmission via the transmit amplifier. The transceiver may turn off the TRSW transistor during reception via the receive amplifier.

### Example Aspects

In addition to the various aspects described above, specific combinations of aspects are within the scope of the present disclosure, some of which are detailed below:

Aspect 1: A transceiver comprising: a transmit amplifier with an output coupled to a node of the transceiver; a receive amplifier with an input coupled to the node of the transceiver; a transmit-receive switch (TRSW) transistor coupled between the node and a reference potential node; and one or more diodes coupled between the node and a gate of the TRSW transistor.

Aspect 2: The transceiver of Aspect 1, wherein the node is coupled to an input-output (IO) node of an integrated circuit including at least a portion of the transceiver.

Aspect 3: The transceiver of Aspect 1 or 2, wherein the one or more diodes include two or more diodes.

Aspect 4: The transceiver according to any of Aspects 1–3, further comprising: a transistor coupled between a voltage rail and the node; and one or more other diodes coupled between the node and a gate of the transistor.

Aspect 5: The transceiver of Aspect 4, further comprising a capacitive element coupled between the voltage rail and the reference potential node.

Aspect 6: The transceiver of Aspect 4 or 5, wherein: the TRSW transistor comprises an n-type transistor; and the transistor is a p-type transistor.

Aspect 7: The transceiver according to any of Aspects 1–6, wherein the TRSW transistor comprises an n-type transistor.

Aspect 8: The transceiver according to any of Aspects 1–7, wherein the gate of the TRSW transistor is coupled to a transmit enable node.

Aspect 9: The transceiver according to any of Aspects 1–8, wherein: the TRSW transistor is configured to be turned on during transmission via the transmit amplifier; and the TRSW transistor is configured to be turned off during reception via the receive amplifier.

Aspect 10: The transceiver according to any of Aspects 1–9, wherein the transmit amplifier comprises a power amplifier (PA), and wherein the receive amplifier comprises a low-noise amplifier (LNA).

Aspect 11: The transceiver of Aspect 10, further comprising a transformer including a primary winding and a secondary winding, wherein: an output of the PA is coupled to the primary winding; and the secondary winding is coupled to the node.

Aspect 12: A method for electrostatic discharge (ESD) protection, comprising: receiving a first signal at a node of a transceiver, wherein the transceiver includes a transmit amplifier with an output coupled to the node, a receive amplifier with an input coupled to the node, and a transmit-receive switch (TRSW) transistor coupled between the node and a reference potential node; and generating, via one or more diodes coupled to the node, a first voltage at a gate of the TRSW transistor based on the first signal.

Aspect 13: The method of Aspect 12, wherein the first signal comprises an electrostatic discharge (ESD) signal, and wherein the method further comprises conducting ESD current between the node and the reference potential via the TRSW transistor based on the ESD signal.

Aspect 14: The method of Aspect 12 or 13, wherein the node is coupled to an input-output (IO) node of an integrated circuit including at least a portion of the transceiver.

Aspect 15: The method according to any of Aspects 12–14, wherein the one or more diodes include two or more diodes.

Aspect 16: The method according to any of Aspects 12–15, wherein the transceiver further comprises a transistor coupled between a voltage rail and the node, and a capacitive element coupled between the voltage rail and the reference potential node, the method further comprising: receiving a second signal at the node of the transceiver; and generating, via one or more other diodes coupled to the node, a second voltage at a gate of the transistor based on the second signal.

Aspect 17: The method of Aspect 16, wherein: the first voltage is generated via the one or more diodes based on the first signal including a positive voltage with respect to a reference potential at the reference potential node; and the second voltage is generated via the one or more other diodes based on the second signal including a negative voltage with respect to the reference potential.

Aspect 18: The method according to any of Aspects 12–17, wherein the TRSW transistor comprises an n-type transistor.

Aspect 19: The method according to any of Aspects 12–18, further comprising: turning on the TRSW transistor during transmission via the transmit amplifier; and turning off the TRSW transistor during reception via the receive amplifier.

Aspect 20: A transceiver comprising: a transmit amplifier with an output coupled to a node of the transceiver; a receive amplifier with an input coupled to the node of the transceiver; a capacitive element coupled between a voltage rail and a reference potential node; a transistor coupled between the capacitive element and the node; and one or more diodes coupled between the node and a gate of the transistor.

The above description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

1. A transceiver comprising:
a transmit amplifier with an output coupled to a node of the transceiver;
a receive amplifier with an input coupled to the node of the transceiver;
a transmit-receive switch (TRSW) transistor coupled between the node and a reference potential node; and
one or more diodes coupled between the node and a gate of the TRSW transistor.

2. The transceiver of claim 1, wherein the node is coupled to an input-output (IO) node of an integrated circuit including at least a portion of the transceiver.

3. The transceiver of claim 1, wherein the one or more diodes include two or more diodes.

4. The transceiver of claim 1, further comprising:
a transistor coupled between a voltage rail and the node; and
one or more other diodes coupled between the node and a gate of the transistor.

5. The transceiver of claim 4, further comprising a capacitive element coupled between the voltage rail and the reference potential node.

6. The transceiver of claim 4, wherein:
the TRSW transistor comprises an n-type transistor; and
the transistor is a p-type transistor.

7. The transceiver of claim 1, wherein the TRSW transistor comprises an n-type transistor.

8. The transceiver of claim 1, wherein the gate of the TRSW transistor is coupled to a transmit enable node.

9. The transceiver of claim 1, wherein:
the TRSW transistor is configured to be turned on during transmission via the transmit amplifier; and
the TRSW transistor is configured to be turned off during reception via the receive amplifier.

10. The transceiver of claim 1, wherein the transmit amplifier comprises a power amplifier (PA), and wherein the receive amplifier comprises a low-noise amplifier (LNA).

11. The transceiver of claim 10, further comprising a transformer including a primary winding and a secondary winding, wherein:
an output of the PA is coupled to the primary winding; and
the secondary winding is coupled to the node.

12. A method for electrostatic discharge (ESD) protection, comprising:
receiving a first signal at a node of a transceiver, wherein the transceiver includes a transmit amplifier with an output coupled to the node, a receive amplifier with an input coupled to the node, and a transmit-receive switch (TRSW) transistor coupled between the node and a reference potential node; and
generating, via one or more diodes coupled to the node, a first voltage at a gate of the TRSW transistor based on the first signal.

13. The method of claim 12, wherein the first signal comprises an electrostatic discharge (ESD) signal, and wherein the method further comprises conducting ESD current between the node and the reference potential via the TRSW transistor based on the ESD signal.

14. The method of claim 12, wherein the node is coupled to an input-output (IO) node of an integrated circuit including at least a portion of the transceiver.

15. The method of claim 12, wherein the one or more diodes include two or more diodes.

16. The method of claim 12, wherein the transceiver further comprises a transistor coupled between a voltage rail and the node, and a capacitive element coupled between the voltage rail and the reference potential node, the method further comprising:
receiving a second signal at the node of the transceiver; and
generating, via one or more other diodes coupled to the node, a second voltage at a gate of the transistor based on the second signal.

17. The method of claim 16, wherein:
the first voltage is generated via the one or more diodes based on the first signal including a positive voltage with respect to a reference potential at the reference potential node; and
the second voltage is generated via the one or more other diodes based on the second signal including a negative voltage with respect to the reference potential.

18. The method of claim 12, wherein the TRSW transistor comprises an n-type transistor.

19. The method of claim 12, further comprising:
turning on the TRSW transistor during transmission via the transmit amplifier; and
turning off the TRSW transistor during reception via the receive amplifier.

20. A transceiver comprising:
a transmit amplifier with an output coupled to a node of the transceiver;
a receive amplifier with an input coupled to the node of the transceiver;
a capacitive element coupled between a voltage rail and a reference potential node;
a transistor coupled between the capacitive element and the node; and
one or more diodes coupled between the node and a gate of the transistor.
